(19) United States
(12) Patent Application Publication
(10) Pub. No.: US 2022/0001991 A1
(43) Pub. Date: Jan. 6, 2022

(54) AIRPLANE SEATS IN THE WAKE OF COVID-19

(71) Applicants: Kwok Wai Cheung, Hong Kong (CN); Peter P. Tong, Mountain View, CA (US); C. Douglass Thomas, Saratoga, CA (US)

(72) Inventors: Kwok Wai Cheung, Hong Kong (CN); Peter P. Tong, Mountain View, CA (US); C. Douglass Thomas, Saratoga, CA (US)

(21) Appl. No.: 17/367,487

(22) Filed: Jul. 5, 2021

Related U.S. Application Data
(60) Provisional application No. 63/048,272, filed on Jul. 6, 2020.

(51) Int. Cl. B64D 11/06; B64D 13/00; B64D 11/00

(52) U.S. Cl. CPC B64D 11/0601; B64D 11/0606; B64D 11/0023; B64D 13/00

(57) ABSTRACT

One embodiment of a seating arrangement of a transportation vehicle includes at least two rows of upper-level seats in a first zone extending a longitudinal direction, a left row of lower-level seats in a second zone on the left of the upper-level seats, and a right row of lower-level seats in a third zone on the right side of the upper-level seats, with the seats arranged either in an acute or an obtuse angle relative to the longitudinal direction, and with the upper-level seats and the lower-level seats being staggered. In the embodiment, the three zones are substantially isolated from one another. For example, going from one zone to the next, a person can go through a door, and each zone can have its substantially separate air ventilation system. In another embodiment, each of the second and the third zones includes single-level seats, with at least an aisle between the single-level seats and the corresponding lower-level seats. The transportation vehicle can be a plane.

### CROSS-REFERENCE TO RELATED APPLICATION

This application claims priority to U.S. Provisional Patent Application No. 63/048,272, filed Jul. 6, 2020, entitled “AIRPLANE SEATS IN THE WAKE OF COVID-19,” and which is hereby incorporated herein by reference.

### BACKGROUND OF THE INVENTION

There's no getting around it: Covid-19 has changed our lives. How we interact, do business, and travel. Airlines in particular are looking at a dismal future. Despite new safety protocols such as temperature checks, capped seating, and face masks, people are scared to travel. It could take years for the industry to regain that trust. Passenger demand in 2020 was down a staggering 95 percent from last year, which will likely leave the world's air carriers down more than half their revenue for 2020.

To regain confidence in the airline industry, changes must be made, particularly in the coach area. Some suggest leaving middle seats empty, but this provides insufficient social distancing, and can do more harm than good for airlines, as passengers still prioritize pricing above all else. Others suggest rotating middle seats to face the other way with added partitions, but this could take more room than expected and still leave passengers facing those in the next row.

It should be apparent from the foregoing that there is a need in the airline industry for a proper, cost-effective way not only to protect passengers, but also quickly earn back trust and revenue.

### SUMMARY OF THE INVENTION

Different embodiments of the invention are described herein. The embodiments can present solutions to today's health and safety concerns. The embodiments can make use of seating arrangements, such as using staggered seats. The embodiments can make use of physical separation barriers. Other embodiments can employ separate air circulation systems. Various embodiments can promote proper hygiene in the wake of Covid-19. Various embodiments can create more premium space in the cabin. Some embodiments can more efficiently make use of the space that is conventionally above the passengers and not used for seating.

In one embodiment, each passenger can have a semi-private cubicle, with significantly increased comfort, privacy, and accessibility. Double-level seating arrangements can fit inside, for example, a standard-size fuselage, and can possibly substantially maintain the overall coach seating capacity, provide individual arm rests, more leg room, and increase seat incline to, for example, at least 35-degree angle, and even to 45-degree angle.

In one embodiment, rows of seats can be set at angles. Each seat can have its own partitions to create semi-private cubicles. Attendants can serve passengers without passing items over other passengers. In some implementations, every passenger can access a seat without pushing past other passengers.

Various embodiments can far better protect passengers from airborne pathogens than traditional conventional single level, non-isolated, seating, even as the number of passengers returns to full or almost full capacity.

Other aspects and advantages of the present invention will become apparent from the following detailed description, which, when taken in conjunction with the accompanying drawings, illustrates by way of example the principles of the invention.

### BRIEF DESCRIPTION OF THE DRAWINGS

FIG. 1 shows one embodiment of the present invention, including a double-level section in a sitting area, with both upper-level and lower-level seats.

FIG. 2 shows a front view of an embodiment of the present invention.

FIG. 3 shows a side view of an embodiment of a row of lower-level seats of the present invention.

FIG. 4 shows an example of how a passenger leaves a lower-level seat of the present invention.

FIG. 5 shows one embodiment of steps to allow a passenger to walk from a lower-level to an upper-level of the present invention.

FIG. 6 shows a top view of one embodiment illustrating steps linking a lower-level to an upper-level, with upper-level seats of the present invention.

FIG. 7 shows a front view of an embodiment of upper-level seats of the present invention.

FIG. 8 shows an angled view of an embodiment of upper-level seats of the present invention.

FIG. 9 shows a top view of an embodiment of the present invention.

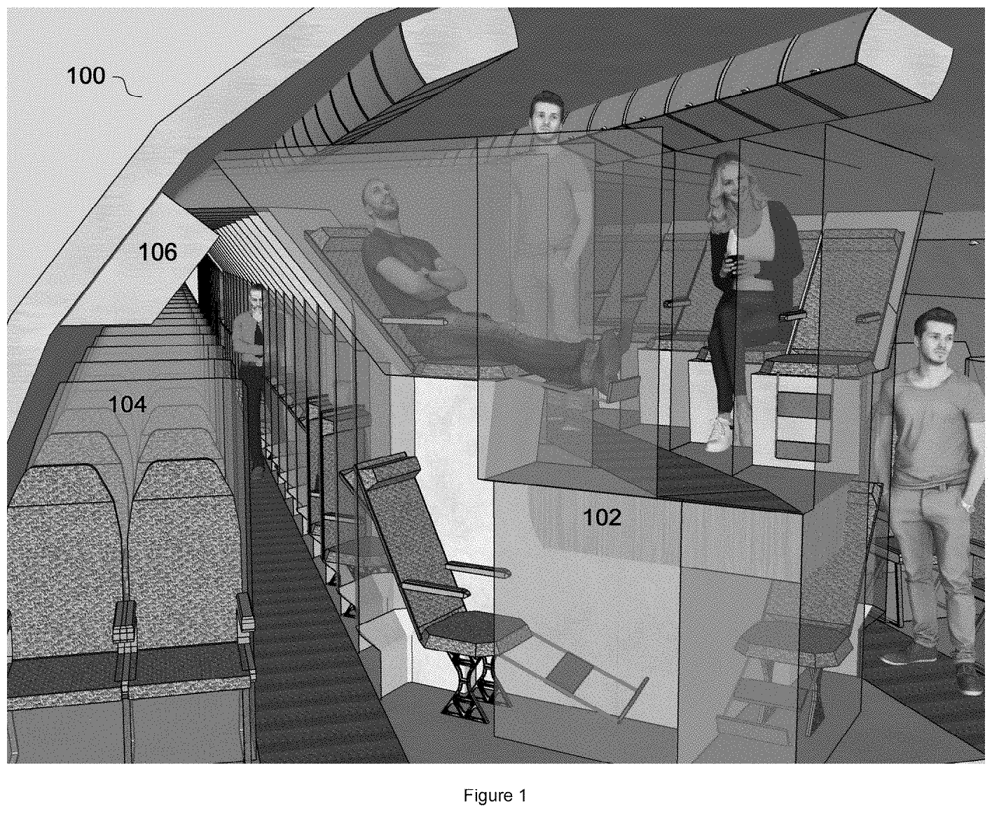

Same numerals in FIGS. 1-9 are assigned to similar elements in all the figures. Embodiments of the invention are discussed below with reference to FIGS. 1-9. However, those skilled in the art will readily appreciate that the detailed description given herein with respect to these figures is for explanatory purposes as the invention extends beyond these limited embodiments.

### DETAILED DESCRIPTION OF THE INVENTION

FIG. 1 shows one embodiment 100. It includes a double-level section 102 in a fuselage or sitting area, with both upper-level seats and lower-level seats. FIG. 1 shows rows of upper-level seats and lower-level seats. Note that the rows in the double-level section shown in FIG. 1 do not extend across the transverse direction of the sitting area, but across the longitudinal direction, such as from the front to the back of the sitting area.

Regarding the upper-level seats in FIG. 1, one row can be arranged with each seat at an acute angle from the longitudinal axis of the sitting area, while the other row of upper-level seats can be arranged at an obtuse angle from the longitudinal axis. The two rows of upper-level seats can be located in a substantially symmetrical manner about the middle of the sitting area.

In this example, the acute angle can be approximately 45 degrees. By changing the acute angle, one can accommodate different cross-sectional widths of the fuselage. The acute angle can be larger for a plane with a wider width. In one embodiment, the acute angle can range from 20 to 70 degrees.

Regarding the lower-level seats in FIG. 1, one row can be arranged with each seat at an acute angle from the longitudinal axis of the sitting area, while the other row of lower-level seats can be arranged at an obtuse angle from the longitudinal axis. The two rows of lower-level seats can be located in a substantially symmetrical manner about the middle of the sitting area. In the example shown in FIG. 1, the acute angle can be approximately 45 degrees. As another illustration, the center line of a seat in one row of lower-level seats can be 45 degrees from the longitudinal axis, while the center line of a seat in the other row of lower-level seats can be 135 degrees from the longitudinal axis, with angles of both center lines measured from the same point on the longitudinal axis.

In one embodiment, the upper-level seats and the lower-level seats can be staggered. For example, each seat has a seat back, a seat base and a leg rest, with each seat having a number of seating positions, such as at least a takeoff and a resting position. When a seat is in its takeoff position, its seat back can be substantially upright relative to its seat base. When a seat is in its resting position, its seat back can be tilted by more than 35 degrees, such as 45 degrees. For an upper-level seat and a lower-level seat that are staggered, at least in one of the of seating positions of the upper-level seat and at least in one of the seating positions of the lower-level seat, the bottom end the upper-level seat is below the top end of the lower-level seat.

In another example, there can be a space with a floor in front of each upper-level seat, allowing a passenger to stand on the floor and to access the corresponding upper-level seat. The floor can extend to or being a part of the aisle in front of the upper-level seat. In one embodiment, for an upper-level seat and a lower-level seat that are staggered, at least in one seating position of the lower-level seat, the floor of the space in front of the upper-level seat is below at least the top end of the lower-level seat.

As shown in FIG. 1, there can be partitions separating each of the double-level seats. Each of the seats can have its own partitions to create a semi-private cubicle.

In different implementations, partitions or barriers can be made from any of a wide variety of materials. They can be natural or synthetic materials, such as plastics (including synthetic polymers, nylon, acrylic, etc.), fabric, metal, fiberglass, alloys, foams, polycarbonate, carbon fiber reinforced polymer, etc. In different embodiments, some partitions can be clear, see-through or transparent; other translucent; and other opaque. In one embodiment, the degree of transparency of a partition can be changed electronically. Also, partitions can be rigid, flexible, or deformable. Further, the partitions do not have to be the same for all the seats.

In one embodiment, the upper and lower level seats can be classified as three separate sub-cabins inside the sitting area: An upper level sub-cabin, a left lower-level sub-cabin and a right lower-level sub-cabin, relative to the longitudinal axis of the sitting area. The upper-level sub-cabin can be accessed via steps from the lower level, which would be further described. Each of the sub-cabins can be essentially self-contained and substantially isolated from the other two sub-cabins. This can increase social distancing and significantly limit potential spreading of virus or germs to a single sub-cabin area, instead of to the entire sitting area. For example, each sub-cabin can have a separate air circulation system, which would be further described below.

FIG. 1 also shows single-level seats, such as the set 104, on one side of the lower-level seats of the double-level section 102. These can be conventional or standard single-level seats. For example, there can be storage bins above the single-level seats, such as storage bin 106. Note that in the example shown in FIG. 1, each row for the single-level seats extend across the transverse direction of the sitting area, not along the longitudinal direction.

In the example shown in FIG. 1, there can be two single-level seats in each transverse row, and there can be no partition between the seats. These seats can be for family members, such as mother and child, to sit next to each other. In other embodiments, there can be more or fewer single-level seats. The example in FIG. 1 also shows partitions between adjacent transverse rows, which would be further described.

There can be another set of single-level seats on the other side of the double-level section 102.

Note that the single-level seats can also be at an acute angle from the longitudinal axis of the sitting area. For example, single-level seats can be arranged at an acute or obtuse angle from the longitudinal axis of the sitting area. They can be in orientations similar to those described in U.S. Pat. No. 7,448,575; see FIG. 29 as an example. U.S. Pat. No. 7,448,575 is incorporated herein by reference for different embodiments, such as for embodiments related to seats at an acute or obtuse angle from a longitudinal axis of a sitting area.

The embodiment in FIG. 1 shows an example of a mixed seating arrangement with both multi-level seats and single-level seats.

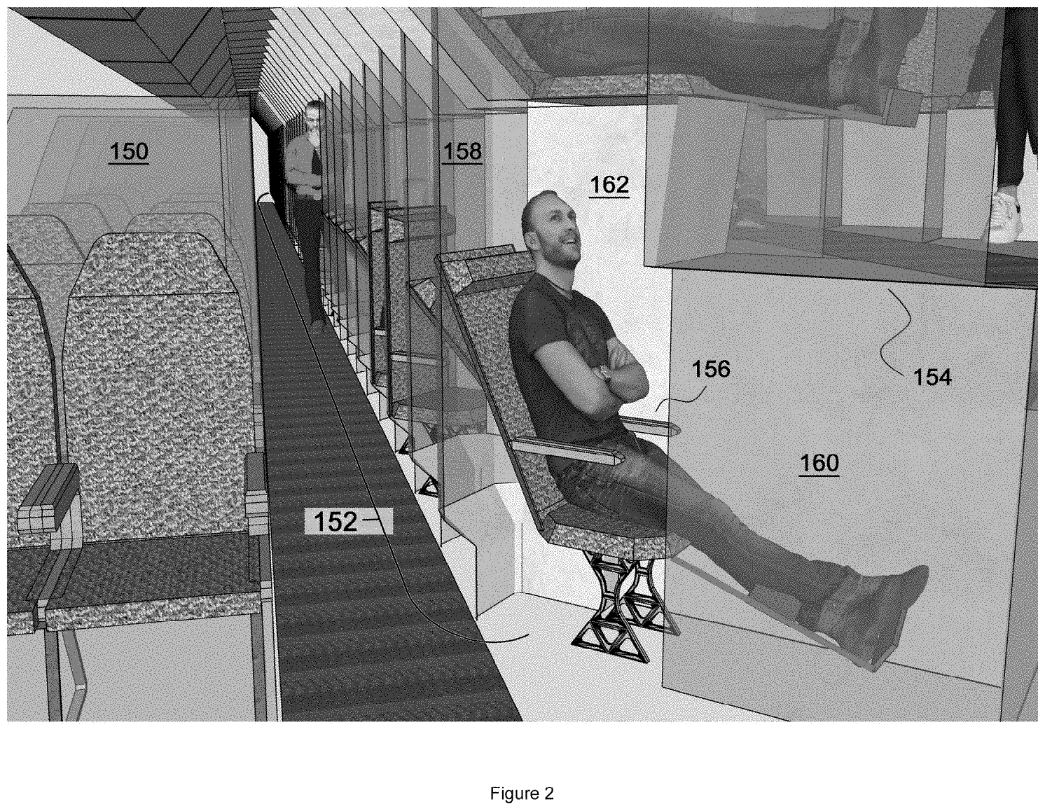

FIG. 2 shows a front view of an embodiment of a row 152 of lower-level seats, such as seat 156. Again, the row 152 of the lower-level seats can be arranged at an acute angle from the longitudinal axis of the sitting area. The seat 156 can be in its resting position, with its seat back reclined and leg rest extended.

In the example shown in FIG. 2, at least in one seating position of the lower-level seat 156, an aisle 154 of the upper level is below at least the top end of the lower-level seat 156. In this example, the level of the aisle is the same as the level of the floor of a space in front of at least an upper-level seat, which allows a passenger to stand on the floor and to access the corresponding upper-level seat from the aisle.

In an embodiment, the lower-level seat 156 is in a semi-private cubicle. Using the seat 156 as an example, one can see that the seat 156 is in a semi-enclosed area. Not only is there a partition or a wall in front of the seat 156, there are two side partitions, 160 and 162, and a back partition 158. All the partitions can extend to their corresponding ceilings to reduce airborne pathogens from going in and out of the cubicle. In an example, a partition can be a transparent wall that reaches up to the top, such as to the bottom of upper-level seats above.

FIG. 2 also shows a front view of an embodiment of single-level seats. Though the single-level seats in each transverse row do not have partitions between them, seats between rows can be separated by partitions, such as partition 150, to reduce the chance of pathogens spreading among the passengers. These partitions, such as partition 150, can be extended all the way to the corresponding ceiling of the single-level seats. There can also be a side panel or partition, wrapping around the side of each of the single-level seats next to the aisle between the lower-level seats and the single-level seats. These side partitions can also extend all the way to the corresponding ceiling of the single-level seats. In the example shown in FIG. 2, a transverse row of two seats can be in semi-private cubicle, with partitions in front, behind, and on the side of them.

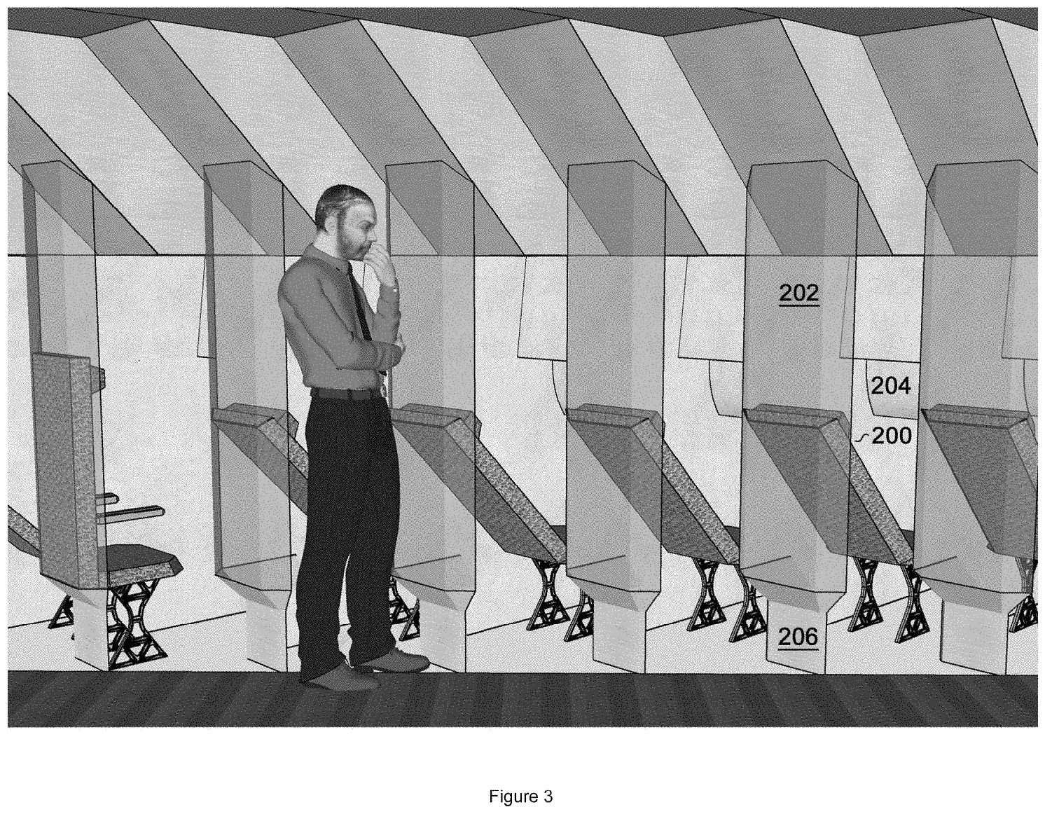

FIG. 3 shows a side view of an embodiment of a row of lower-level seats. Each of the seats can be in a semi-private cubicle. In one embodiment, the back partition for a seat do not have to be of uniform width. For example, for the seat 200, its back partition can be of a wider width 202 higher up and of a narrower width 206 at the bottom. This can give more space for a passenger to leave the cubicle. Also, FIG. 3 shows a storage bin 204 for the seat 200.

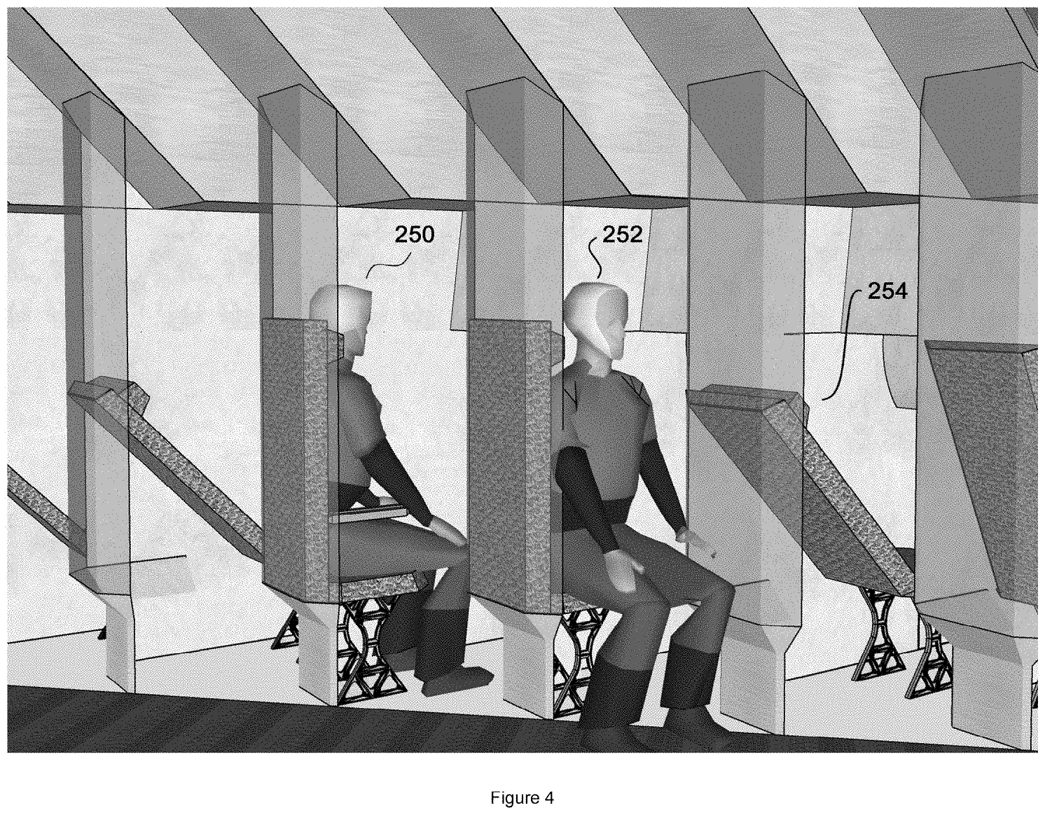

FIG. 4 shows an example of how a passenger leaves a lower-level seat. In this example, passengers in the lower-level seats can be adjacent to a lower-level aisle. For example, to leave a seat, a passenger can change the seat back to its upright position. Then the passenger can slide the seat backward toward its back petition. This can be done by, for example, sliding the seat backward relative to the floor, sliding the seat base relative to the floor, or other mechanisms. One example is shown by seats 254 and 250. After sliding the seat backward toward its back petition, the passenger can lift up an arm rest of the corresponding seat, and rotate to move out of the seat to the lower-level aisle, as, for example, shown by the passenger in seat 252.

Regarding moving forward or backward, in one embodiment, a lower-level seat can be moved forward or backward relative to the orientation of the seat. In other words, the seat is not moving forward or backward along the longitudinal direction of the sitting space. Instead, the seat, for example, can be moved in a direction substantially perpendicular to the seat back (which can be the acute angle from the longitudinal axis of the sitting area), to create a walking space to get in and out of the seat. The walking space allows, for example, the passenger to walk to the front of the seat to sit down.

The outside corners of the seat bases of lower-level seats can be rounded or can be removed, as shown, for example, in FIG. 3 or FIG. 4, to create more room for passengers to access the seats.

In one embodiment, the lower-level seats can be adjacent to a lower-level aisle. With an adjacent aisle, a passenger can access each of the lower-level seats directly from the aisle, without the need to go through or across another seat.

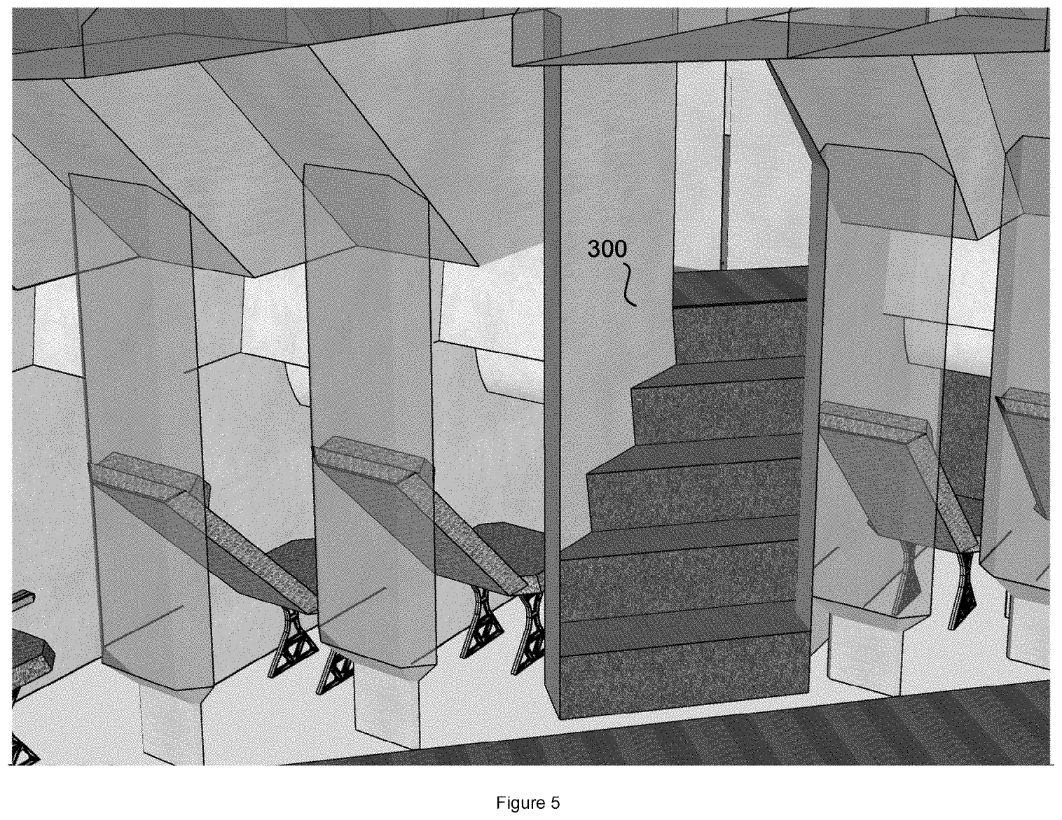

FIG. 5 shows one embodiment of a number of steps 300 to allow a passenger to walk from a lower-level aisle to upper-level seats. There can be multiple sets of steps at different sections of the sitting area, leading from the lower level to the upper level. This can be for convenience and safety purpose.

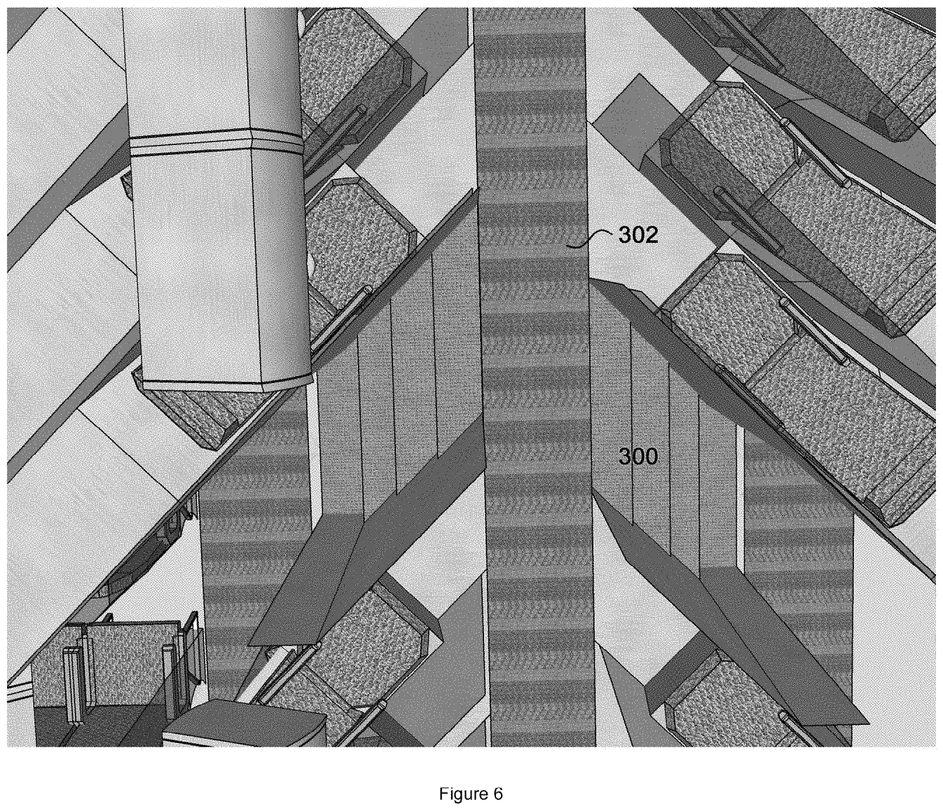

FIG. 6 shows a top view of one embodiment illustrating the steps 300 linking a lower-level aisle to an upper-level aisle 302. The upper-level aisle 302 in FIG. 6 can be the same as the upper-level aisle 154 in FIG. 2.

FIG. 6 also shows a number of upper-level seats. The steps 300 can be substantially in the same orientation as the upper-level seats. For example, if a row of the upper-level seats is arranged at an acute angle from the longitudinal axis of the sitting area, the general direction of the steps 300 can also be substantially at the acute angle from the longitudinal axis of the sitting area. In one embodiment, there can be partitions or walls on two sides of the steps 300, and they can also extend to their corresponding ceilings. Also, in the embodiment shown in FIG. 6, upper-level seats can also be adjacent to the aisle 302.

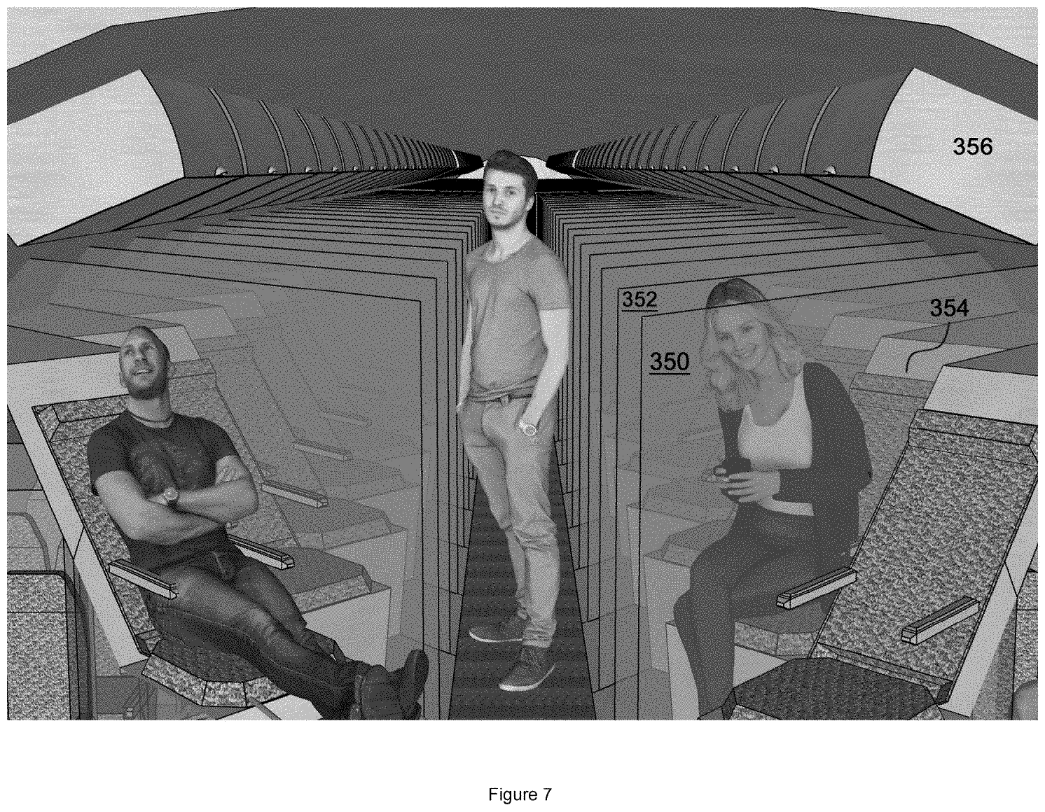

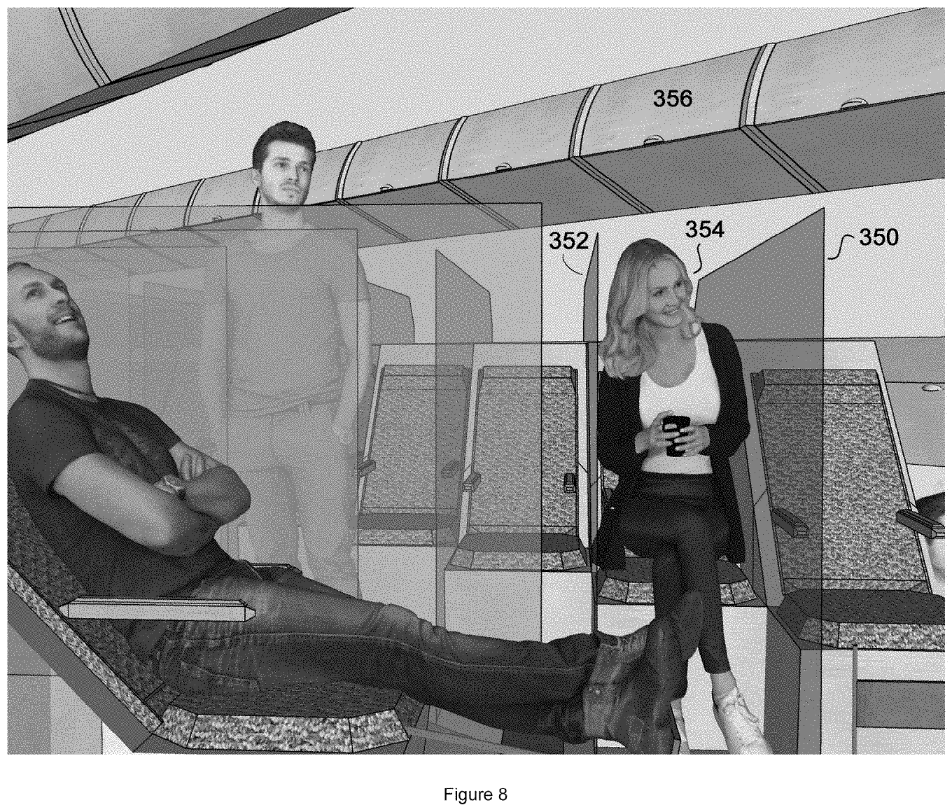

FIG. 7 shows a front view of an embodiment of upper-level seats. The upper level seats can be adjacent to the aisle 302 in FIG. 6. A passenger can walk on the aisle 302 to access an upper-level seat, such as seat 354. FIG. 8 shows an angled view of the embodiment of upper-level seats, such as seat 354.

In one embodiment, upper-level seats can be in semi-private cubicles. For example, the seat 354 can have partitions 350 and 352 on either side. The partitions 350 and 352 can extend to their corresponding ceiling to reduce airborne pathogens to go from one seat to the next. As shown in FIG. 8, there can be a storage bin 356 above the seat 354.

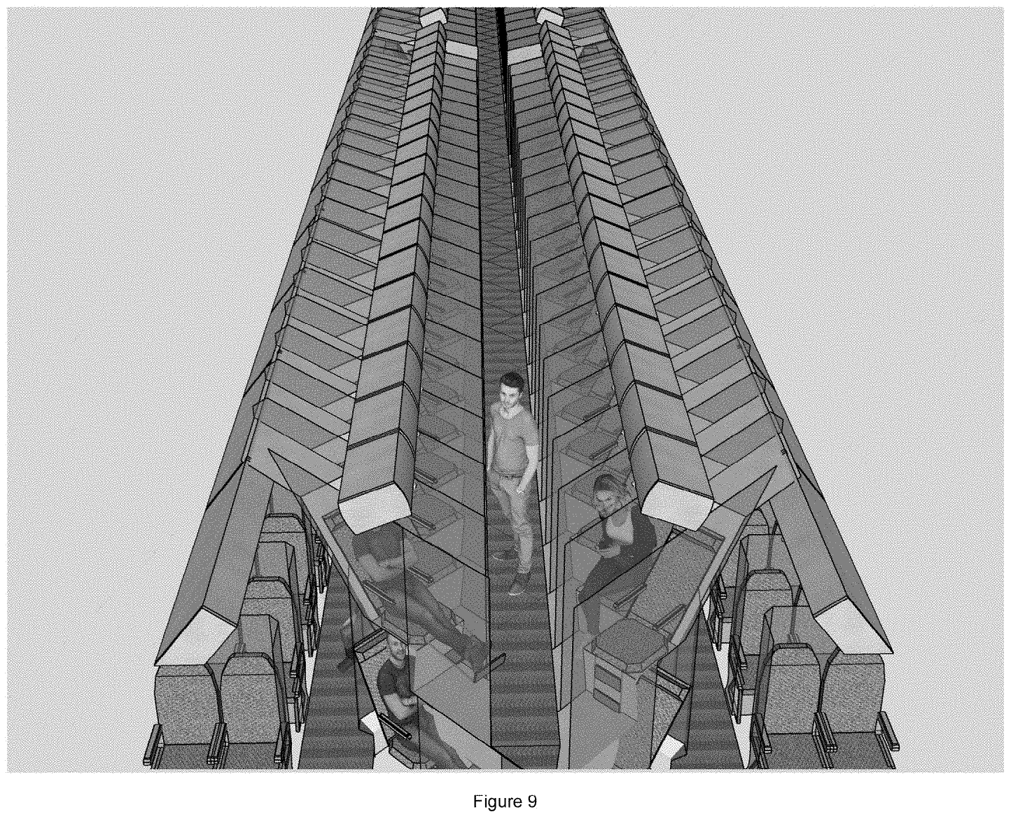

FIG. 9 shows a top view of an embodiment. The figure also shows single-level seats on either side of the double-level seats.

The double-level seats have a number of other additional benefits. For example, neighboring seats do not have to be right next to each other. Instead, each seat can extend forwards or backwards relative to its neighboring seats. With such a configuration, each passenger can substantially have the full use of the arm rests, without the need to share them with neighboring passengers, even without a partition between them. With both arm rests relatively free for a passenger's use, in one embodiment, the seat width can be effectively increased by 2″ relative to conventional seats with seats fully aligned right next to each other. Also, as for example in the embodiment shown in FIG. 7, upper-level seats across an upper-level aisle do not have to face each other. Relative to the longitudinal axis of the sitting area, for opposite seats, one can be at an acute angle and the other can be at an obtuse angle. Passengers in such opposite seats are not forced to face or look at each other. This further helps to reduce germs to spread across the aisle.

A number of embodiments have been described regarding airplane seats with partitions to create semi-private cubicles. In one embodiment, each semi-private cubicle can also have a door. The door can be a left or a right opening door, or can be a rolling door that rolls down from top, or up from bottom. To access such a cubicle, one can open a door. This can create fully private cubicles. In one embodiment, instead of a door, there can be a curtain, which can be an electric curtain. The electric curtain can be a rolling curtain, such as rolling down from the top. The curtain can also be a manual curtain, such as a drapery. Such door or curtain or other types of seat-entrance coverage can further reduce the chance of spreading of pathogens or germs.

Seat-entrance coverages can be implemented for the different type of seats, such as upper-level seats and lower-level seats. For an upper-level seat, a coverage, such as a curtain, can be installed in front of the seat. For a lower-level seat, a coverage, such as a door, can be installed at the opening to access the seat. For example, a door can be installed inside the opening to access the seat, or the door can be opened into the lower-level seat, instead of opening out into a lower-level aisle.

One embodiment includes a device to lift service trolley, such as for meals and drinks, from a lower level, such as the level of lower-level seats, to the area of upper-level seats. The device can be a small elevator or an electric lift. In one embodiment, the device can have multiple openings to facilitate the transfer of a service trolley between the levels.

In one embodiment, air circulation in different parts of the sitting area can be controlled separately. For example, the sitting area can be separated into three sub-cabins: an upper level sub-cabin, a left lower-level sub-cabin, and a right lower-level sub-cabin. The lower-level sub-cabins can include lower-level seats with corresponding single-level seats adjacent to them. For example, the left lower-level sub-cabin can include left lower-level seats on one side of a lower-level aisle, and a number of single-level seats on the other side of the aisle.

Each sub-cabin can be substantially isolated from other sub-cabins via, for example, doors. To illustrate, there can be doors at the beginning and/or the end of the steps 300 shown in FIG. 5. The door(s) can be rolling door(s) rolling down from the top, which can save space. With the door(s) closed, the upper-level seats shown in FIG. 5 can be substantially isolated from seats in the lower level. The left lower-level sub-cabin can similarly be isolated from the right lower-level sub-cabin via doors between the two sub-cabins.

In one embodiment, air circulation can be confined within each sub-cabin. For example, each sub-cabin can have its separate air filter, such as its separate HEPA air filter, to reduce air going from one sub-cabin to another sub-cabin. In another embodiment, fresh air from outside the airplane can be brought in separately for each sub-cabin to mix with filtered air within the sub-cabin.

In another embodiment, there can be fans at the top of doors. For example, for the steps 300 shown in FIG. 5, there can be two doors, one at the top of the steps, and another at the bottom. At the top of each door, there can be fans blowing down, and there can be an outlet at the bottom to receive the air. In one embodiment, the fans can be directional fans, blowing from the top toward the outlet at the bottom. This can reduce the spreading of virus or germs, such as from one sub-cabin to another sub-cabin.

In one embodiment, a seat can have a physical door. For example, the upper-level seat, such as seat 354, can have a door separating the seat from the aisle 302. The door for the seat can also be closed to create, for example, a private cubicle. The air-circulation system for the seat 354 can be isolated (such as shut off) from the rest of the airplane. In one example, there are air vents for the seat 354, and the air vents can be closed to isolate the air inside the seat 354 to be within the private cubicle. A portable air conditioner and/or air tank can be brought into the private cubicle for a passenger.

Different embodiments can use different methods to control air flow. In one embodiment, air flow around a seat can be controlled to prevent or limit air in a cubicle around a seat from traveling to areas outside the cubicle. One approach to control air flow is via the positioning of air input and exhaust vents in a cubicle.

In one embodiment, air supply can be sent via pipes through a centralized air distribution system to a set of cubicles. The system can direct air via, for example, a star or tree topology. For example, the outlet of such a pipe can be located at separate overhead vent(s) of one of such cubicles. The cubicle can have one or more corresponding exhaust vents, which can be near the floor of the cubicle. In one embodiment, air from the exhaust vents can combine with air from other exhaust vents in the other cubicles. The combined exhaust air can be directed out of the aircraft. Then the air supply for each of the cubicles can be substantially isolated from the other cubicles in the set of cubicles.

The airplane can include coach seats and seats of other classes, such as business class and first class. Each class can be in its own separate sitting area. In one embodiment, a class of seats can be isolated from another class of seats. For example, there can be doors separating one class from the next. In one embodiment, a sitting area for a class can have its own separate air. For example, the first-class sitting area can have its own air filter, and the filtered air can be mixed with fresh air separately brought in from outside the airplane.

In one embodiment, a sitting area can have its own air previously stored in the airplane. For example, the air previously stored in the airplane for first-class seats can be Swiss mountain air. In one embodiment, a different class of seats can have a different type of air from a different part of the world.

In one embodiment, a cubicle around a seat can have its own separately-filtered air. The separately-filtered air can be mixed with its own type of air (such as air from outside the plane) for the cubicle. The cubicle can be a private cubicle, with its door. In one embodiment, the private cubicle can be a private room.

A number of embodiments have been described with two rows of lower-level seats and two rows of upper-level seats. Other embodiments can include additional rows. Multiple rows of staggered seats, and seats in different configurations, have been described in U.S. Pat. No. 7,448,575, which is incorporated herein by reference.

A number of embodiments have been described regarding airplanes. Different embodiments described can be applicable to other types of transportation systems, such as a bus or a ship.

The various embodiments, implementations and features of the invention noted above can be combined in various ways or used separately. Those skilled in the art will understand from the description that the invention can be equally applied to or used in other various different settings with respect to various combinations, embodiments, implementations or features provided in the description herein.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

Also, in this specification, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

1. A seating arrangement in a passenger sitting space of a transportation vehicle comprising:
at least two rows of upper-level seats, extending along a longitudinal direction of the passenger sitting space, with each row including at least two seats;
at least one left row of lower-level seats extending along the longitudinal direction of the passenger sitting space, with the row including at least two seats, and with the at least left row of lower-level seats being on the left side of the upper-level seats; and
at least one right row of lower-level seats extending along the longitudinal direction of the passenger sitting space, with the row including at least two seats, and with the right row of lower-level seats being on the right side of the upper-level seats;
wherein the upper-level seats and the lower-level seats are configured to be arranged either in an acute or an obtuse angle relative to the longitudinal direction of the sitting space,
wherein each of the lower-level seats has a top end, with a plurality of seating positions,
wherein each of the upper-level seats has a bottom end, with a plurality of seating positions,
wherein for each of the upper-level seats and for each of the lower-level seats, at least in one of the plurality of seating positions of that upper-level seat, its bottom end is positioned below the top end of at least in one of the plurality of seating positions of that lower-level seat,
wherein the at least two rows of upper-level seats are in a first zone,
wherein the at least one left row of lower-level seats are in a second zone, and
wherein the at least one right row of lower-level seats are in a third zone,
wherein the first zone, the second zone, and the third zone are substantially isolated from one another such that at least going from one zone to the next, a person needs to go through a door so that at least air in one zone does not freely circulate to the other two zones to at least reduce germs from spreading from one zone to the other zones.

2. A seating arrangement as recited in claim 1, wherein the second zone includes single-level seats, with at least an aisle between the single-level seats and the at least one left row of lower-level seats.

3. A seating arrangement as recited in claim 2, wherein the third zone includes single-level seats, with at least an aisle between the single-level seats and the at least one right row of lower-level seats.

4. A seating arrangement as recited in claim 2,
wherein the aisle has a first side and a second side,
wherein the at least one left row of lower-level seats are next to the first side of the aisle, and
wherein at least a plurality of the single-level seats are next to the second side of the aisle.

5. A seating arrangement as recited in claim 1, wherein the transportation vehicle is a plane.

6. A seating arrangement as recited in claim 1,
wherein there are stairs going from the first zone to the second zone, and
wherein going up the stairs needs to at least go through a door so that at least the air in the first zone does not freely circulate to the second zone.

7. A seating arrangement as recited in claim 1,
wherein each zone has its air ventilation system, and
wherein ventilation system in a zone is substantially separate from the ventilation systems in the other two zones such that at least air in one ventilation system does not freely mix with air in the other two ventilation systems.
